(19) United States
(12) Patent Application Publication
(10) Pub. No.: US 2013/0107575 A1
(43) Pub. Date: May 2, 2013

(54) LIGHT GUIDE PLATE AND ILLUMINATING DEVICE

(71) Applicant: LI-YING WANG HE, Tu-Cheng (TW)

(72) Inventor: LI-YING WANG HE, Tu-Cheng (TW)

(73) Assignee: HON HAI PRECISION INDUSTRY CO., LTD., Tu-Cheng (TW)

(21) Appl. No.: 13/340,606

(22) Filed: Dec. 29, 2011

(30) Foreign Application Priority Data
Oct. 27, 2011 (TW) 100139011

(51) Int. Cl. F21V 8/00

(52) U.S. Cl. 362/613; 362/620

(57) ABSTRACT

A light guide plate includes a light emitting surface and a micro structure positioned on the light emitting surface. The micro structure includes a plurality of pyramids projecting from the light emitting surface. Each of the pyramids includes a bottom surface and a plurality of side surfaces connected to the bottom surface. An included angle between each side surface and the bottom surface of each pyramid is in the range from about 15 degrees to about 25 degrees. An illuminating device including the light guide plate is also provided.

### BACKGROUND

1. Technical Field

The present invention relates generally to a light guide plate and an illuminating device using the light guide plate.

2. Description of Related Art

Light guide plates are often used to expand a number of point light sources to an area light source. Yet, part of light usually is reflected at the light emitting surface of the light guide plate and does not emit from the light guide plate. This reduces the luminosity of the area light source.

What is needed, therefore, is a light guide plate and an illuminating device, which could overcome the limitations described above.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a sectional view of an illuminating device according to a first embodiment, the illuminating device including light guide plates.

FIG. 2 is an isometric view of one of the light guide plates of FIG. 1.

FIG. 3 is an enlarged, partial view of the light guide plate of FIG. 2.

FIG. 4 is a chart showing the luminosity distribution of the illuminating device of FIG. 1.

FIG. 5 is a sectional view of an illuminating device according to a second embodiment.

FIG. 6 is a sectional view of an illuminating device according to a third embodiment.

FIG. 7 is a top view of an illuminating device according to a fourth embodiment.

### DETAILED DESCRIPTION

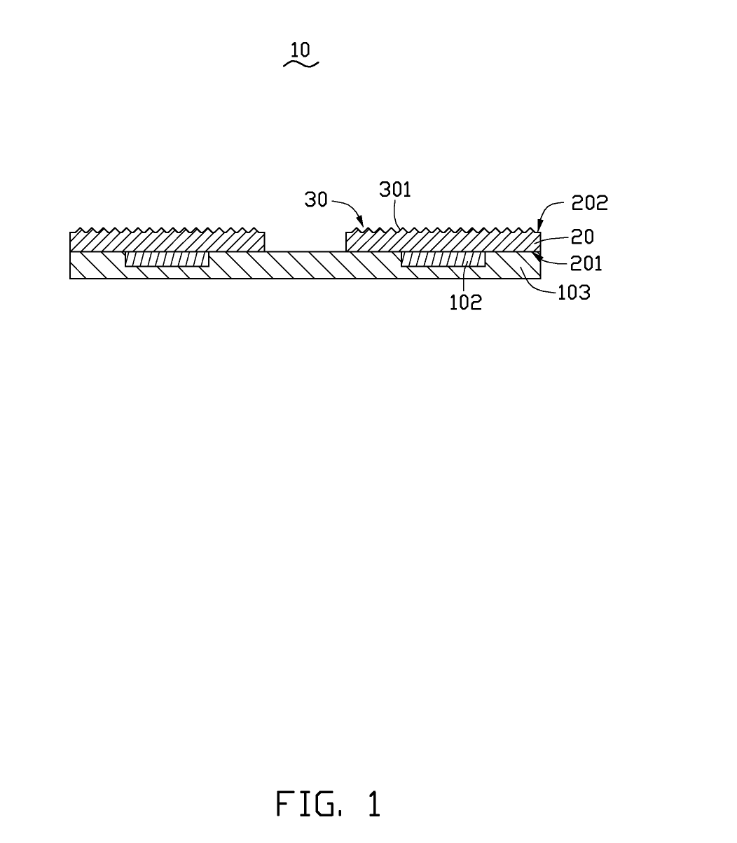

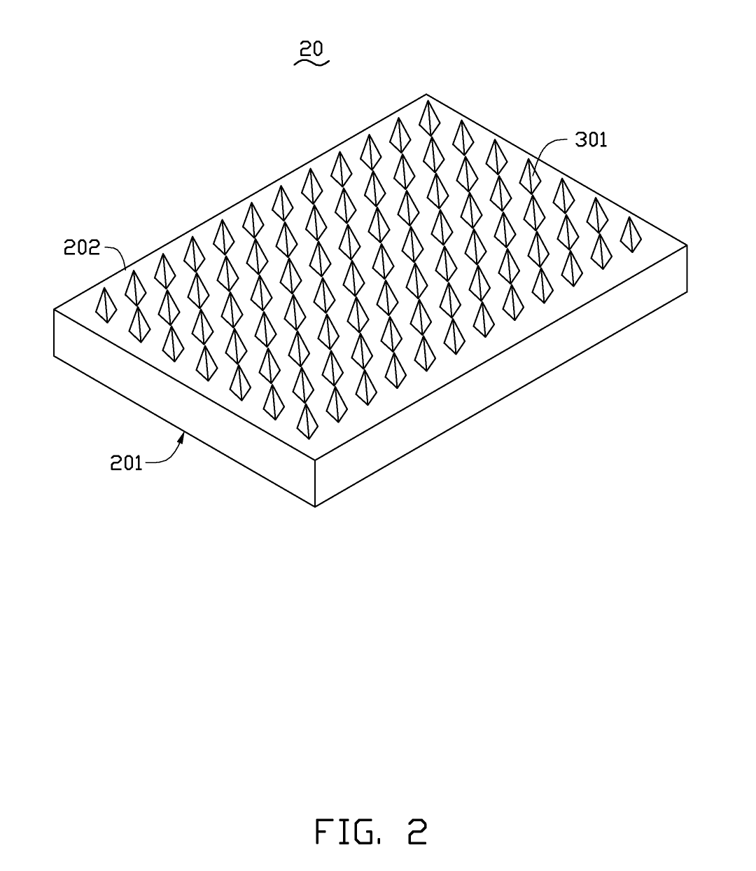

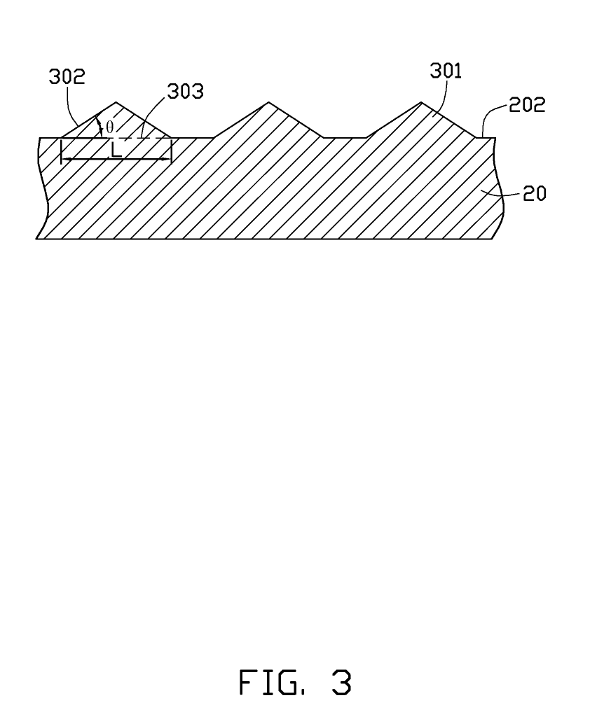

FIGS. 1 to 3, an illuminating device 10 according to a first embodiment is shown. The illuminating device 10 includes a number of light sources 102 and a number of light guide plates 20. Each of the light guide plates 20 is disposed on a respective one of the LEDs 102. In this embodiment, the light sources 102 include two light emitting diodes (LEDs), and the illuminating device 10 includes two light guide plates 20.

The light guide plate 20 is made of polymethylmethacrylate (PMMA), polycarbonate (PC) or other transparent material. The refractive index of the light guide plate 20 is in the range of about 1.47 to about 1.55.

The light guide plate 20 includes a light incident surface 201 and an opposite light emitting surface 202. A micro structure 30 is formed on the light emitting surface 202. The micro structure 30 includes a number of regular triangular pyramids 301 projecting from the light emitting surface 202. Each triangular pyramid 301 includes a bottom surface 303 and three side surfaces 302. The bottom surface 303 is in equilateral triangle shape. The equilateral triangle shape has a height “L” in the range of about 0.02 microns to about 0.10 microns. The pyramids 301 reduce the light reflection occurred on the light emitting surface 202.

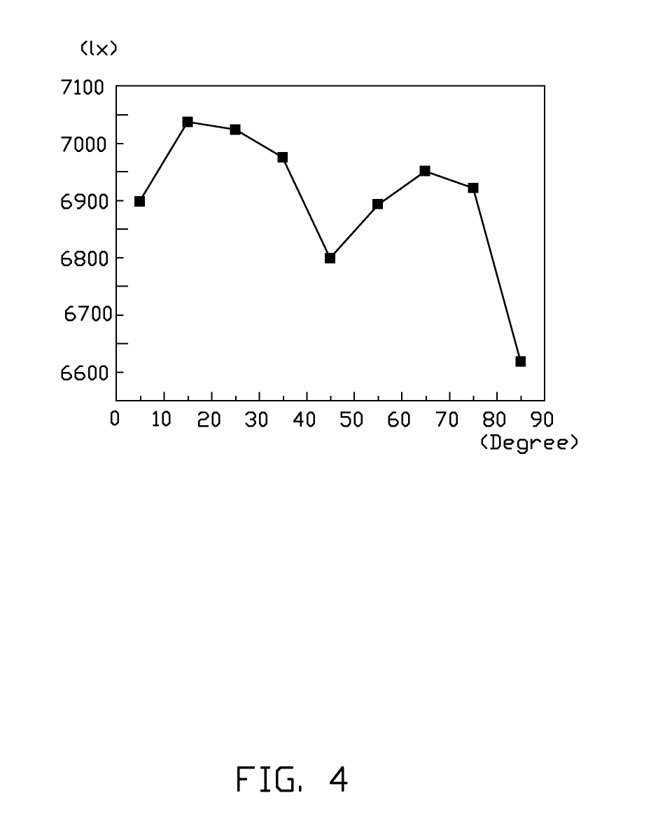

FIG. 4 shows the relationship between the luminosity of the illuminating device 10 and the included angle θ between the side surface 302 and the bottom surface 303 of the pyramid 301. It can be seen from FIG. 4 that the luminosity is relatively higher when the included angle θ is in the range of about 15 degrees to about 25 degrees, and is highest when the included angle θ is about 15 degrees.

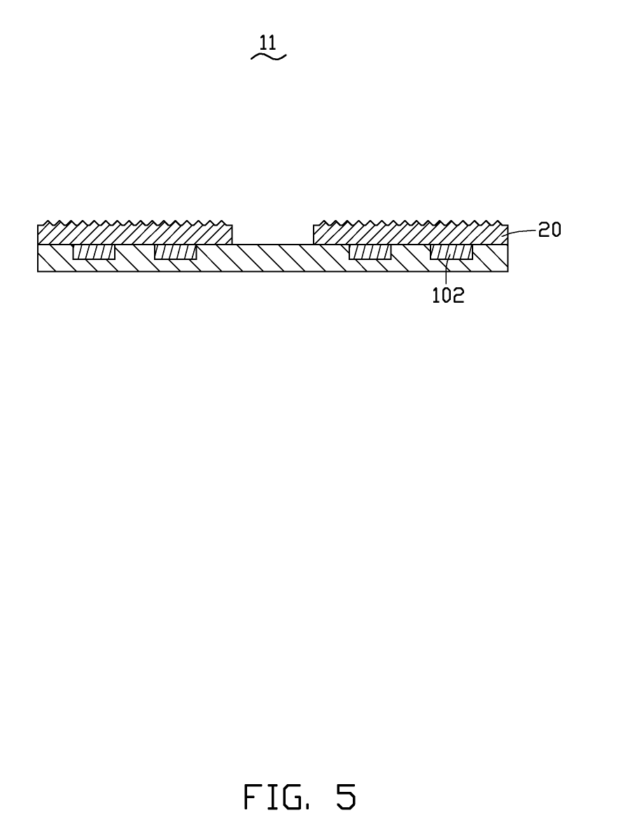

Referring to FIG. 5, an illuminating device 11 according to a second embodiment is shown. The illuminating device 11 is similar to the illuminating device 10 except that each light guide plate 20 is disposed on two LEDs 102.

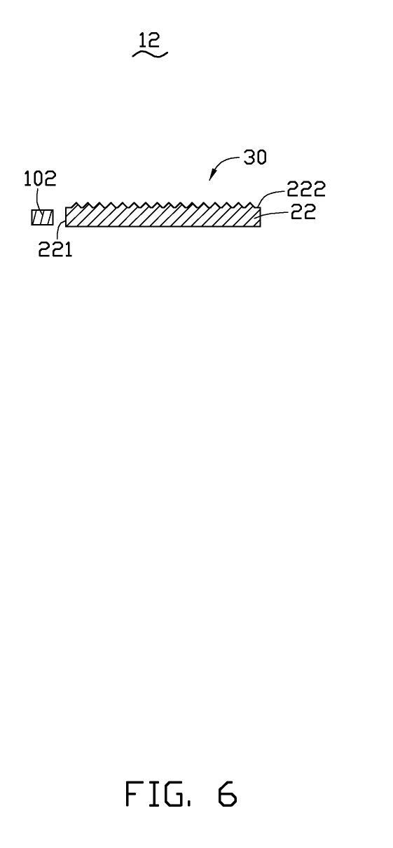

Referring to FIG. 6, an illuminating device 12 according to a third embodiment is shown. The illuminating device 12 is similar to the illuminating device 10 except that the illuminating device 12 includes a light guide plate 22 which includes a light incident surface 221 and a light emitting surface 222, and the light incident surface 221 is perpendicularly connected to the light emitting surface 222. The micro structure 30 is positioned on the light emitting surface 222. One LED 102 is positioned on a side of the light guide plate 22 adjacent to the light incident surface 221.

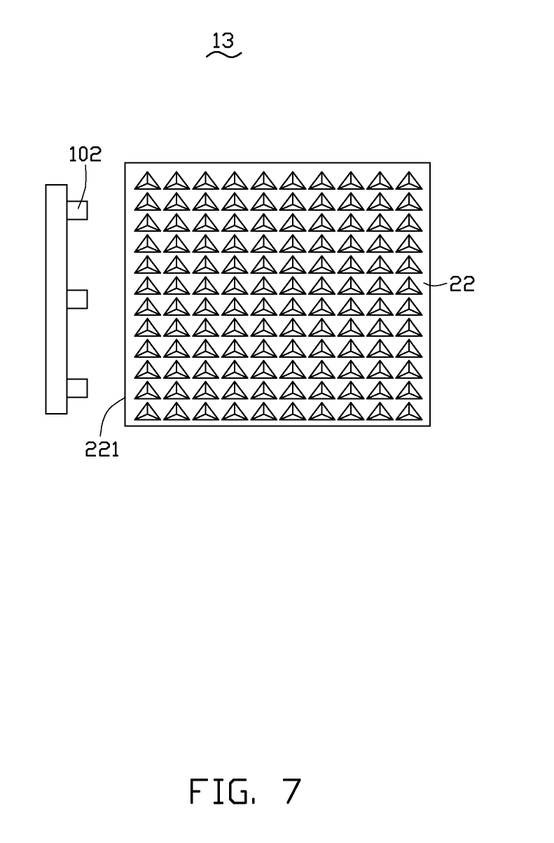

Referring to FIG. 7, an illuminating device 13 according to a fourth embodiment is shown, the illuminating device 13 is similar to the illuminating device 12 except that three LEDs 102 are disposed on a side of the light guide plate 22 adjacent to the light incident surface 221.

It will be understood that the above particular embodiments are shown and described by way of illustration only. The principles and the features of the present disclosure may be employed in various and numerous embodiments thereof without departing from the scope of the disclosure. The above-described embodiments illustrate the scope of the disclosure but do not restrict the scope of the disclosure.

What is claimed is:

1. A light guide plate, comprising:
a light emitting surface; and
a micro structure positioned on the light emitting surface, the micro structure comprising a plurality of pyramids projecting from the light emitting surface, each of the pyramids comprising a bottom surface and a plurality of side surfaces connected to the bottom surface, an included angle between each side surface and the bottom surface of each pyramid being in the range from about 15 degrees to about 25 degrees.

2. The light guide plate of claim 1, wherein the included angle is about 15 degrees.

3. The light guide plate of claim 1, further comprising a light incident surface perpendicularly connected to the light emitting surface.

4. The light guide plate of claim 1, further comprising a light incident surface opposite to the light emitting surface.

5. The light guide plate of claim 1, wherein the refractive index of the light guide plate is in the range from about 1.47 to about 1.55.

6. The light guide plate of claim 1, wherein each of the pyramids is a regular triangular pyramid.

7. An illuminating device comprising:
a plurality of light sources; and
a plurality of light guide plates, each light guide plate comprising a light incident surface adjacent to one of the plurality of light sources, a light emitting surface, and a micro structure positioned on the light emitting surface, the micro structure comprising a plurality of pyramids projecting from the light emitting surface, each of the pyramids comprising a bottom surface and a plurality of side surfaces connected to the bottom surface, an included angle between each side surface and the bottom surface of each pyramid being in the range from about 15 degrees to about 25 degrees.

8. The illuminating device of claim 7, wherein the included angle is about 15 degrees.

9. The illuminating device of claim 7, wherein the refractive index of the light guide plate is in the range from about 1.47 to about 1.55.

10. An illuminating device comprising:
a plurality of light sources; and
a light guide plate comprising a light incident surface adjacent to the plurality of light sources, a light emitting surface, and a micro structure positioned on the light emitting surface, the micro structure comprising a plurality of pyramids projecting from the light emitting surface, each of the pyramids comprising a bottom surface and a plurality of side surfaces connected to the bottom surface, an included angle between each side surface and the bottom surface of each pyramid being in the range from about 15 degrees to about 25 degrees.

11. The illuminating device of claim 10, wherein the included angle is about 15 degrees.

12. The illuminating device of claim 10, wherein the refractive index of the light guide plate is in the range from about 1.47 to about 1.55.
